(19) United States
(12) Patent Application Publication
(10) Pub. No.: US 2020/0370539 A1
(43) Pub. Date: Nov. 26, 2020

(54) WIND-TURBINE ROTOR BLADE AND METHOD FOR PRODUCING A WIND-TURBINE ROTOR BLADE

(71) Applicant: Wobben Properties GmbH, Aurich (DE)

(72) Inventor: Daniel VINKE, Aurich (DE)

(21) Appl. No.: 16/605,758

(22) PCT Filed: Apr. 24, 2018
(86) PCT No.: PCT/EP2018/060445

§ 371 Date: Oct. 16, 2019

(30) Foreign Application Priority Data
Apr. 25, 2017 (DE) 10 2017 108 818.0

(51) Int. Cl. F03D 80/30; F03D 1/06

(52) U.S. Cl. CPC F03D 80/30; F05B 2280/2006; F05B 2230/90; F03D 1/0675

(57) ABSTRACT

There is provided a wind turbine rotor blade having a rotor blade root and a rotor blade tip. The rotor blade has a lightning protection system with a lightning protection conductor which has a galvanic connection to the rotor blade root region. The lightning protection system has a region of the rotor blade surface, to which a heatable paint or a heatable coating is applied, wherein that region is galvanically coupled to the lightning protection conductor so that a lightning strike in the heatable paint can be suitably dissipated.

### BACKGROUND

### Technical Field

The invention concerns a wind turbine rotor blade and a method of producing a wind turbine rotor blade.

### Description of the Related Art

Rotor blades of a wind turbine are known in many different forms. Because of the height of a nacelle of the wind turbine and the length of the rotor blades, the rotor blades of the wind turbines have to comply with the lightning protection requirements.

On the German patent application from which priority is claimed the German Patent and Trade Mark Office searched the following documents: DE 20 2013 007 659 U1, EP 1 187 988 B1 and EP 2 806 160 A1.

### BRIEF SUMMARY

Provided is a wind turbine rotor blade with improved lightning protection.

Thus there is provided a wind turbine rotor blade having a rotor blade root and a rotor blade tip. The rotor blade has a lightning protection system with a lightning protection conductor which has a galvanic connection to the rotor blade root region. The lightning protection system has a region of the rotor blade surface, to which a heatable coating in the form of a heatable paint is applied, wherein that region is galvanically coupled to the lightning protection conductor so that a lightning strike in the heatable paint can be suitably dissipated.

According to an aspect of the present invention the wind turbine rotor blade has at least one lightning receptor which is also galvanically coupled to the lightning protection conductor. In this case the region around the at least one lightning protection conductor is provided with heatable paint or enamel. In other words the surface around the lightning receptor has a heatable paint or enamel. The heatable paint serves to conduct the lightning strike to the lightning receptors in order to prevent damage to the surface in particular in the region of the lightning receptors.

According to an aspect of the present invention the heatable paint has carbon nanomaterials and graphite.

According to an aspect of the present invention the surface of the rotor blade can be provided with the heatable paint according to the invention to protect the surface of the rotor blade. In that way non-conductive parts of the rotor blade can be integrated into the lightning protection system.

According to an aspect of the present invention the heatable paint can also be at least partially applied subsequently to the surface of the rotor blade in order further to improve an already existing lightning protection system.

According to an aspect of the present invention the applied heatable paint can be tied to the lightning protection system for example by way of the lightning protection receptors.

The heatable coating can be provided in the form of strips between the rotor blade tip and the rotor blade root. The heatable coating can be coupled to the rest of the lightning protection system in the region of the rotor blade root.

Also provided is a method of producing a wind turbine rotor blade. The rotor blade is produced from a fiber composite material and a lightning protection system is integrated. In that case there is provided in particular a lightning dissipation conductor in the interior of the rotor blade. A heatable paint as part of the lightning protection system is applied to the surface of the rotor blade and galvanically connected to the lightning protection conductor.

The present invention also concerns the use of a heatable paint or a heatable coating as part of a lightning protection system of a wind turbine rotor blade.

In particular a heatable coating on an acrylic basis is provided for use up to 100° C., having carbon nanomaterials and graphite.

The thickness of the heatable paint can be between 40 μm and 1 mm.

Further configurations of the invention are subject-matter of the appendant claims.

### BRIEF DESCRIPTION OF THE SEVERAL VIEWS OF THE DRAWINGS

Advantages and embodiments by way of example of the invention are described more fully hereinafter with reference to the drawing.

FIG. 1 shows a diagrammatic view of a wind turbine, and

FIG. 2 shows a diagrammatic view of a wind turbine rotor blade.

### DETAILED DESCRIPTION

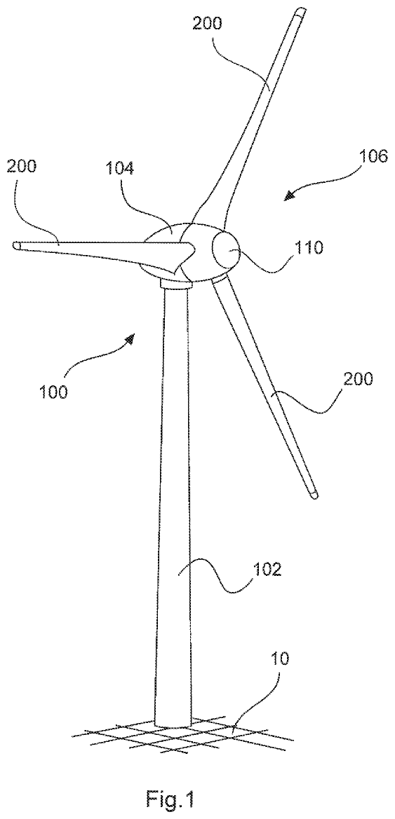

FIG. 1 shows a diagrammatic view of a wind turbine. The wind turbine 100 has a tower 102 and a nacelle on the tower 102. Provided at the nacelle 104 is an aerodynamic rotor 106 having three rotor blades 200 and a spinner 110. The aerodynamic rotor 106 is caused to rotate in operation of the wind turbine by the wind and thus also rotates a rotor or rotor member of a generator which is directly or indirectly coupled to the aerodynamic rotor 106. The electric generator is arranged in the nacelle 104 and generates electrical energy. The pitch angles of the rotor blades 200 can be varied by pitch motors at the rotor blade roots 108b of the respective rotor blades 200.

The wind turbine also has a lightning protection system which ensures that lightning which strikes one of the three rotor blades 200 is suitably dissipated. For that purpose a lightning dissipation conductor is provided in the interior of the rotor blade and a further lightning dissipation conductor arrangement is provided in the interior of the wind turbine.

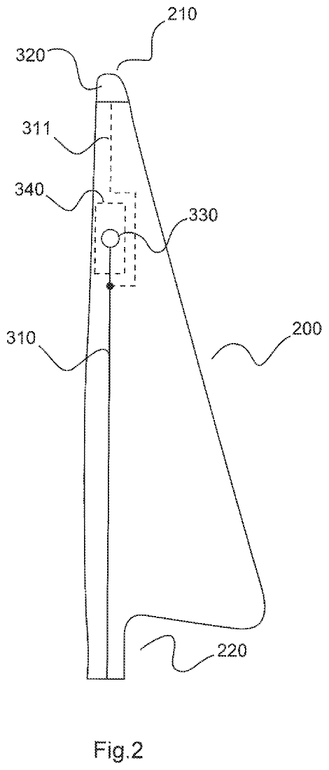

FIG. 2 shows a diagrammatic view of a wind turbine rotor blade. FIG. 2 shows a rotor blade 200 with a rotor blade tip 210 and a rotor blade root 220. The rotor blade has a lightning protection system 300. The lightning protection system 300 has in particular a lightning protection conductor 310 for example in the interior of the rotor blade and optionally at least one lightning receptor 330. The rotor blade tip 210 can optionally have a further lightning receptor 320 which is galvanically coupled to the lightning protection conductor 310 by means of a lightning protection conductor arrangement 311. The lightning protection system 300 further has a heatable paint or enamel or a heatable coating 340 on the surface of the rotor blade. That heatable coating 340 is galvanically coupled to the lightning protection conductor 310 in order to be able to suitably dissipate a lightning strike.

According to an aspect of the present invention the heatable coating or the heatable paint 340 is provided in the region of the lightning receptor 330. Galvanic coupling of the heatable coating 340 to the lightning protection conductor 310 is then also effected by means of the lightning receptor.

The heatable coating or the heatable paint can be produced on an acrylate basis and can contain carbon nanomaterials and graphite.

An example of such a heatable paint is the heatable paint: Carbo e-Therm ACR-100 1W. The density of that paint is 1.08 g/cm³. The color can be anthracite. The solids content is 39-41% (plastic+polymer). The storage life is 6 months. The solvent basis is water. The minimum film-forming temperature is about 14° C. The pH-value is about 7-8. The viscosity (shearing rate 100 s⁻¹) is 700-800 mPas.

The product properties of the dried layer are as follows: temperature use range −18° C. to 100° C.; specific resistance: 1050-1100 Ωμm; layer resistance: R/square from 5.5Ω (with 200 μm layer thickness); recommended minimum layer thickness: 40 μm.

The thickness of the paint is between 30 μm and 2 mm, preferably between 40 μm and 1 mm.

1. A wind turbine rotor blade, comprising:
a rotor blade tip;
a rotor blade root; and
a lightning protection system,
wherein the lightning protection system has a lightning protection conductor and a heatable coating of paint on a surface of the rotor blade, wherein the heatable coating is galvanically coupled to the lightning protection conductor, and
wherein the heatable coating is based on an acrylate basis and includes carbon nanomaterials and graphite.

2. The wind turbine rotor blade according to claim 1, further comprising:
at least one lightning receptor,
wherein the heatable coating in a region of the lightning receptor, and wherein the heatable coating is galvanically coupled to the lightning protection conductor by the lightning receptor.

3. (canceled)

4. The wind turbine rotor blade according to claim 1 wherein the thickness of the paint is between 30 μm and 2 mm.

5. A method of producing a wind turbine rotor blade, the method comprising:
producing a shell of the wind turbine rotor blade from a fiber composite material;
providing at least one lightning protection conductor on a surface of the shell of the wind turbine rotor blade;
applying a heatable coating of paint on the surface of the shell of the wind turbine rotor blade; and
galvanically coupling the heatable coating to the at least one lightning protection conductor,
wherein the heatable coating is based on an acrylate basis and includes carbon nanomaterials and graphite.

6. A method comprising:
using a heatable coating as part of a lightning protection system of a wind turbine rotor blade, wherein the heatable coating is applied as a paint to a surface of the wind turbine rotor blade and is galvanically coupled to a lightning protection conductor.
wherein the heatable coating is based on an acrylate basis and includes carbon nanomaterials and graphite.

7. The wind turbine rotor blade according to claim 1 wherein the thickness of the paint is between 40 μm and 1 mm.
